(19) United States
(12) Patent Application Publication
(10) Pub. No.: US 2005/0187651 A1
(43) Pub. Date: Aug. 25, 2005

(54) Numerically controlled laser machining apparatus

(76) Inventors: Fumiaki Kimura, Ebina-shi (JP); Kaoru Matsumura, Ebina-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/060,505

(22) Filed: Feb. 18, 2005

(30) Foreign Application Priority Data
Feb. 20, 2004 (JP) 2004-045389

(51) Int. Cl. G06F 19/00; B23K 26/38

(52) U.S. Cl. 700/166; 219/121.7

(57) ABSTRACT

There is provided a laser machining apparatus that requires no machining program to be prepared in advance and that is capable of increasing a work efficiency and a product reliability even for a workpiece in which a spot to be machined cannot be specified in advance. The laser machining apparatus is provided with a machining program generating unit comprising a line camera and an image processing unit. The line camera scans a surface of the workpiece mounted on a Y table before machining. The machining program generating unit specifies a spot to be machined from the image data obtained by the line camera and makes up a machining program based on the specified spot to be machined. An NC unit controls the machining of the workpiece based on the machining program made up as described above.

### BACKGROUND OF THE INVENTION

1. Field of the Invention

The present invention relates to a numerically controlled laser machining apparatus for boring a hole in a workpiece mounted on a table by irradiating a laser beam.

2. Description of Related Art

As Japanese Patent Laid-Open No. 2000-343260 discloses, a prior art numerically controlled laser machining apparatus has been arranged so as to irradiate a laser beam to a design-wise center coordinate of a hole to be machined described in advance in a machining program.

However, when a hole is to be bored at a center of a specific spot formed in a previous step, the center coordinate of the spot to be machined may vary within a machining allowance. Or, the very position to be machined itself may vary depending on a workpiece.

FIGS. 4A, 4B and 4C show plan views of a workpiece processed in a previous step, wherein FIG. 4A is a whole view of the workpiece 1, FIG. 4B is an enlarged view showing an IC chip 2 and FIG. 4C is a partially enlarged view of the workpiece 1.

As shown in FIG. 4A, the square IC chips 2 are disposed in grid on the substrate (workpiece) 1. A pad 3 is formed at any one of four corners of the IC chip 2 in the previous step as shown in FIGS. 4B and 4C. In machining such workpiece 1, an operator has been used to prepare a machining program by manual input while making reference to the position of the pad 3 before machining. Therefore, it has been unable to improve the work efficiency.

Still more, the position of the pad 3, e.g., lower right or upper right corner, in the IC chip 2 has been used to specified without measuring the position of the pad 3 by assuming that the center coordinate of the pad 3 is one as instructed in the design in preparing the machining program. Therefore, there has been a case when the machined hole deviates from the pad 3, thus degrading the product reliability of the IC chip 2.

It is therefore an object of the invention to provide a numerically controlled laser machining apparatus that requires no machining program to be prepared in advance and is capable of improving the work efficiency and the product reliability even for a workpiece in which a position to be machined cannot be specified in advance.

### BRIEF SUMMARY OF THE INVENTION

According to one aspect of the invention, a numerically controlled laser machining apparatus for machining a hole in a workpiece mounted on a table by irradiating a laser beam based on a machining program is provided with:
an image scanner for scanning a surface of the workpiece mounted on the table before machining; and
an image processing unit for specifying a spot to be machined from the image data obtained by the image scanner to make up a machining program based on the specified spot to be machined: and
the numerically controlled laser machining apparatus bores the workpiece by irradiating a laser beam based on the machining program thus made up.

According to another aspect of the invention, the image processing unit makes up a machining program for boring a reference hole at a predetermined position based on the specified spot to be machined to bore the reference hole in the workpiece by irradiating a laser beam based on the machining program thus made up.

Because the numerically controlled laser machining apparatus machines the workpiece by recognizing the actual position to be machined as described above, it is able to machine at high precision.

Additional objects and advantages of the invention will be apparent from the following detailed description of a preferred embodiment thereof, which are best understood with reference to the accompanying drawings.

### BRIEF DESCRIPTION OF THE DRAWINGS

FIG. 1 is a structural view of an inventive numerically controlled laser machining apparatus;

FIG. 2 is a flowchart showing an operation of an inventive numerically controlled laser machining apparatus;

FIG. 3 is a plan view of a workpiece; and

FIGS. 4A, 4B and 4C are plan views showing a workpiece processed in a previous step, wherein FIG. 4A is a whole view of the workpiece, FIG. 4B is an enlarged view of an IC chip, and FIG. 4C is a partially enlarged view of the workpiece.

### DETAILED DESCRIPTION OF THE INVENTION

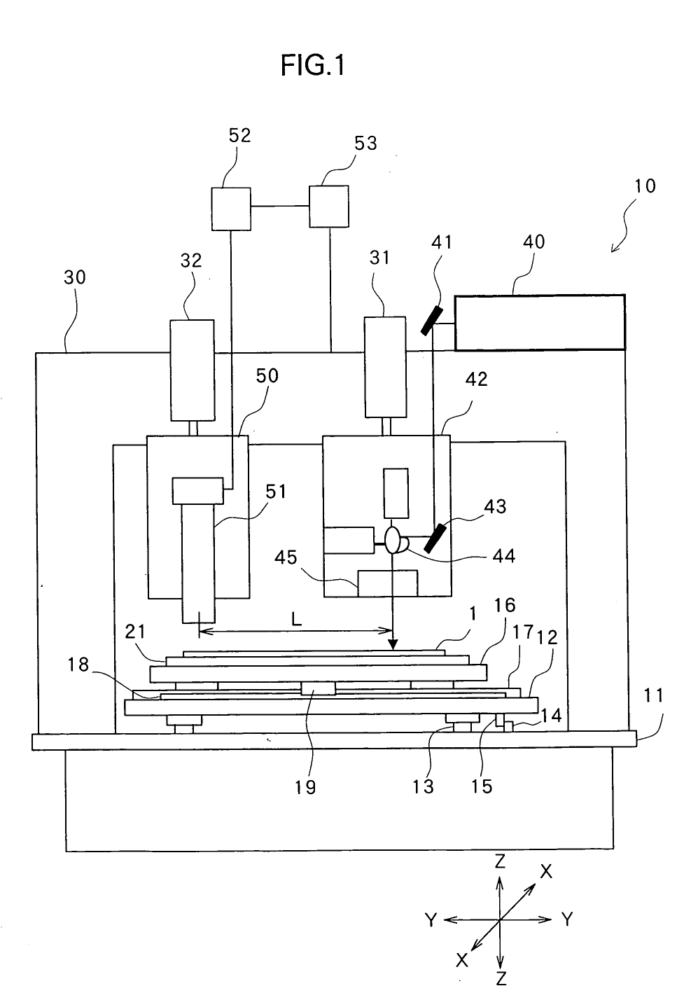

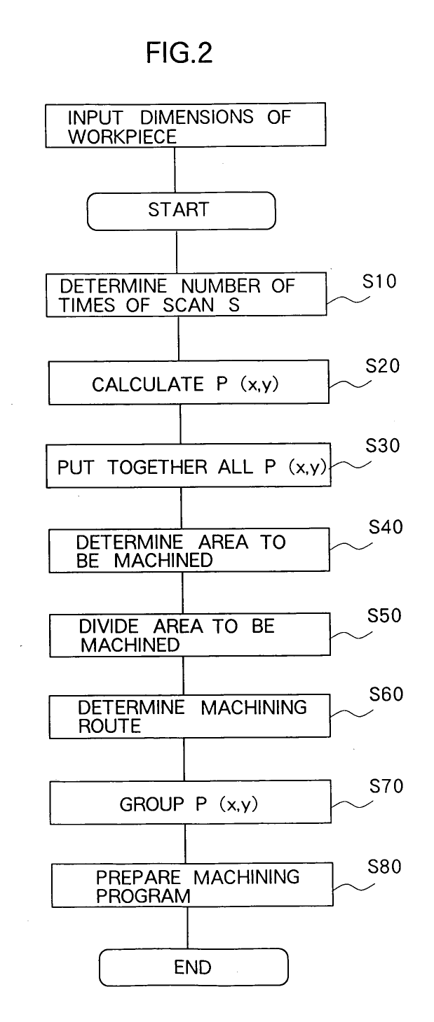

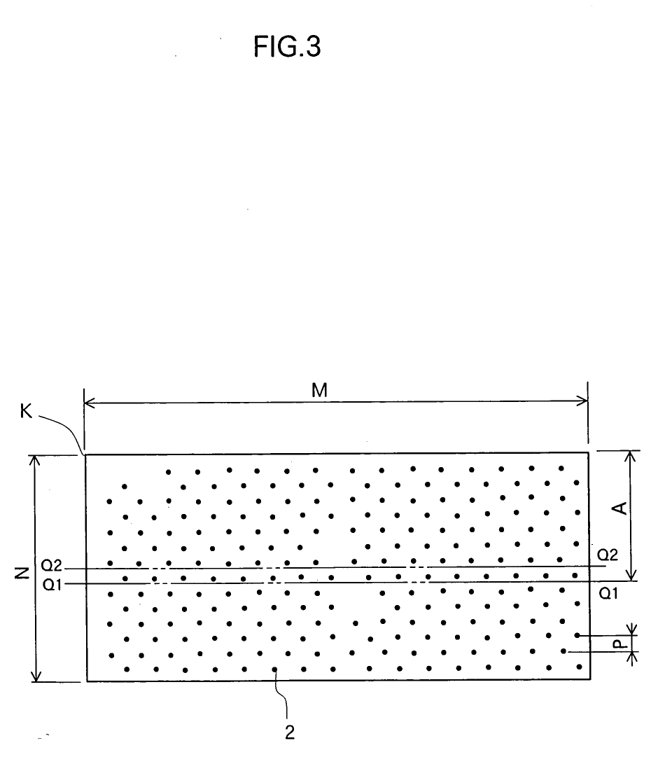

A mode for carrying out a numerically controlled laser machining apparatus on the basis of the invention will be explained below with reference to the accompanying drawings. FIG. 1 is a structural view of the inventive numerically controlled laser machining apparatus 10, FIG. 2 is a flowchart showing an operation of the inventive numerically controlled laser machining apparatus, and FIG. 3 is a plan view of a workpiece.

A linear guide 13 disposed on a bed 11 of the laser machining apparatus 10 enables an X table 12 to be movable in the direction of front and back of the face of the drawing, i.e., in the X-axis direction perpendicular to the face of the drawing. A linear scale 14 is disposed on the bed 11 in parallel with the linear guide 13. A sensor 15 is disposed at the position facing to the linear scale 14 on the X table 12. An NC unit 53 controls the position of the X table 12 accurately by means of the linear scale 14 and the sensor 15.

A linear guide 17 disposed on the X-table 12 enables a Y-table 16 to be movable in the lateral direction, i.e., in they-axis direction. A linear scale 18 is disposed on the X-table 12 in parallel with the linear guide 17. A sensor 19 is disposed at the position facing to the linear scale 18 on the X table 16. The NC unit 53 controls the position of the X table 16 accurately by means of the linear scale 18 and the sensor 19.

A workpiece 1 is positioned on the Y-table 16 by a sucking table 21.

A gate-type column 30 is fixed on the bed 11.

Motors 31 and 32, a laser oscillator 40 and a mirror 41 are disposed on the gate-type column 30.

The motor 31 is capable of moving a base 42 vertically, i.e., in the Z direction, in the figure. A mirror 43, a pair of optical mirrors 44 and an fè lens 45 are disposed on the base 42.

The motor 32 is capable of moving a camera base 50 vertically, i.e., in the Z direction, in the figure. A line camera 51, i.e., image scanning means, is disposed on the camera base 50. Image pickup elements not shown in the line camera 51 are disposed in the X-axis direction. A possible imaging length of the line camera 51 is A (see FIG. 3) and a distance between the center of the image pickup elements of the line camera 51 and the center of the fè lens 45 is L.

The line camera 51 is connected with an image processing unit 52 as an exemplary machining program generating unit. The image processing unit 52 is also connected with the NC unit 53. The image processing unit 52 makes up a machining program described later and controls each section together with the NC unit 53.

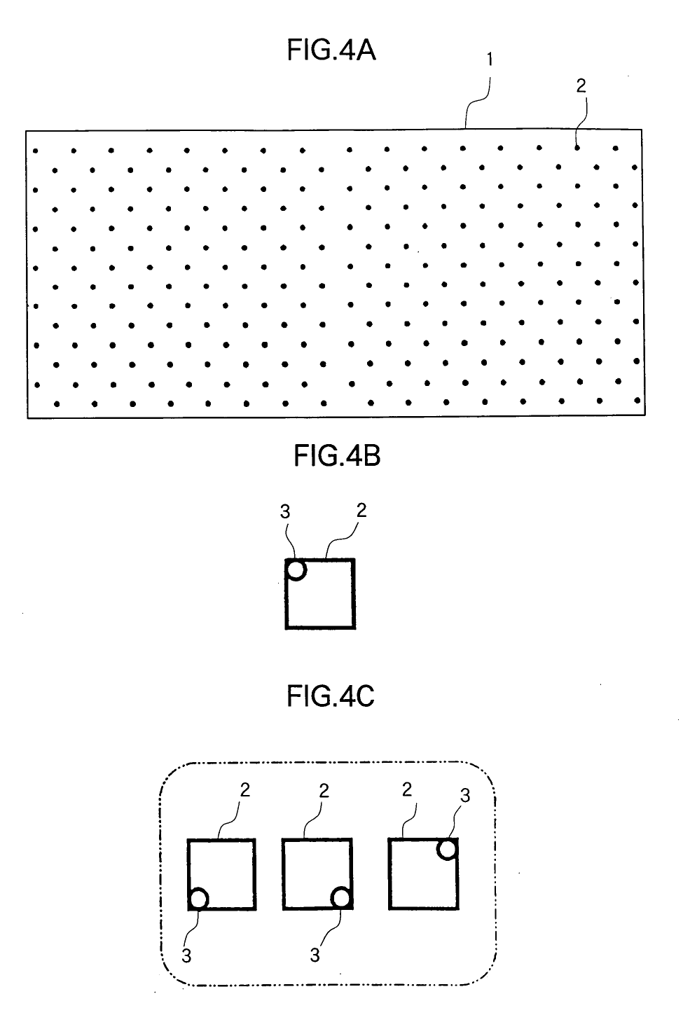

Next, an operation of the inventive machining program generating unit will be explained by exemplifying a case of machining the workpiece shown in FIG. 4.

After adjusting and fixing the center of the workpiece 1 with the center of the Y-table 16, dimensions of the workpiece 1, i.e., a length N in the X-axis direction, a length M in the Y-axis direction and a pitch p between the IC chips 2 in the X-axis direction are inputted to the unit (see FIG. 3).

When a machining start button not shown is turned on, the NC unit 53 divides the length N by the length A to calculate a number of times of scan S (Step S10). When N>A here, the number of times of scan S turns out to be a multiple number, so that the NC unit 53 determines the number of times of scan S so that at least one row of the IC chip 2 in the Y-axis direction overlaps as shown in FIG. 3. In case of the workpiece 1 shown in FIG. 3, it is determined to scan a first area above Q1-Q1 in the first time and to scan a second area below Q2-Q2 in the second time.

In the present embodiment, a reading origin K in reading the workpiece 1 is set at the upper left apex of the workpiece 1, so that the rear edge of the line camera 51 is adjusted to the reading origin K by moving the X-table 12 and the Y-table 16. Then, the workpiece 1 is scanned by the line camera 51 per predetermined sampling time while moving the Y-table 16 in the left direction in FIG. 1. The image processing unit 52 calculates a center coordinate P (x, y) of the pad 3 from the image data outputted from the line camera 51 and from the position of the Y-table 16. Then, after moving the Y-table 16 by the distance M, the X table 12 is moved forward by a distance A leaving one row of the IC chips 2 to position the line camera 51 in the second area. Then, the Y-table 16 is moved by the distance M in the right direction to calculate a center coordinate P (x, y) of the pad 3 in the second area (Step S20). Next, the image processing unit 52 puts together the center coordinate P (x, y) obtained in the first area and the center coordinate P (x, y) obtained in the second area into one data (Step S30).

Next, the image processing unit 52 determines an area to be machined based on the center coordinate P (x, y) thus obtained. That is, the image processing unit 52 determines a difference m between the least x-coordinate xmin and the largest x-coordinate xmax as a length in the X-axis direction of the area to be machined and a difference n between the least y-coordinate ymin and the largest y-coordinate ymax as a length in the Y-axis direction of the area to be machined (Step S40).

Next, the image processing unit 52 divides the lengths m and n by a machining range which is determined by the size of the fè lens (Step S50). Then, the image processing unit 52 determines a machining route (Step S60), puts the center coordinates P (x, y) per area to be machined in order of the machining route (Step S70) and allocates the center coordinates P (x, y) of the spots to be machined in the machining program (Step S80).

The image processing unit 52 makes up the machining program through the steps described above.

Next, an operation of the laser machining apparatus 10 during machining will be explained.

A laser beam outputted from the laser oscillator 40 enters the pair of optical mirrors 44 via the mirrors 41 and 43 to be positioned in the X and Y directions, passes through the fè lens 45, vertically enters the workpiece 1 and bores a hole at the center of the pad 3.

Preferably, a reference hole may be bored for a post-processing. That is, the reference holes O1 and O2 may be bored in advance by adding in the machining program a center coordinate O1 of one reference hole as O1 (xmin−5, ymin−5) and a center coordinate 02 of the other reference hole as (xmax+5, ymax+5).

The present invention is applicable not only to the laser machining apparatus but also to other machining apparatuses such as a printed board drilling apparatus for drilling a printed board by using a drill.

Still more, although the image processing unit 52 has been arranged so as to makes up the machining program in the embodiment described above, it is also possible to arrange so that a calculating unit of the NC unit 53 has the function of generating the machining program.

While the preferred embodiments have been described, variations thereto will occur to those skilled in the art within the scope of the present inventive concepts which are delineated by the following claims.

1. A numerically controlled laser machining apparatus for boring a hole in a workpiece mounted on a table by irradiating a laser beam based on a machining program, comprising:
image scanning means for scanning a surface of the workpiece mounted on the table before machining; and
machining program generating means for specifying a spot to be machined from the image data obtained by said image scanning means to make up the machining program based on the specified spot to be machined;
said numerically controlled laser machining apparatus boring the workpiece by irradiating a laser beam based on said machining program made up as described above.

2. A numerically controlled laser machining apparatus for boring a hole in a workpiece mounted on a table by irradiating a laser beam based on a machining program, comprising:
an image scanner for scanning a surface of a workpiece mounted on the table before machining; and
a machining program generating unit for specifying a spot to be machined from the image data obtained by said image scanner to make up the machining program based on the specified spot to be machined;
said numerically controlled laser machining apparatus boring the workpiece by irradiating a laser beam based on said machining program made up as described above.

3. The numerically controlled laser machining apparatus according to claim 2, wherein said machining program generating unit makes up a machining program for boring a reference hole at a predetermined position based on said specified spot to be machined to bore the reference hole in said workpiece by irradiating a laser beam based on said machining program made up as described above.
